(19) United States
(12) Patent Application Publication
(10) Pub. No.: US 2021/0341094 A1
(43) Pub. Date: Nov. 4, 2021

(54) Apparatus for Holding a Crane Block

(71) Applicant: Anthony James Jacobs, II, Spring Hill, FL (US)

(72) Inventor: Anthony James Jacobs, II, Spring Hill, FL (US)

(21) Appl. No.: 17/000,718

(22) Filed: Aug. 24, 2020

Related U.S. Application Data
(60) Provisional application No. 63/017,804, filed on Apr. 30, 2020.

(51) Int. Cl. F16M 11/22; B60P 7/135; B65D 19/00; B65D 19/44

(52) U.S. Cl. CPC F16M 11/22; B60P 7/135; B65D 19/0026; B65D 19/44; F16M 2200/08; B65D 2519/00815; B65D 2519/00059; B65D 2519/00273; B65D 2519/00288; B65D 2519/00323; B65D 2519/00333; B65D 2519/00024

(57) ABSTRACT

A crane block holder includes a base made of steel of a thickness of at least ½ inch with several holes cut or formed therein. Each hole has an inner dimension. There are several crane block support arms, each of which has an arm portion connected to a peg that has a shoulder. An outer dimension of the peg is less than or equal to the inner dimension of the holes allowing snug insertion. An outer dimension of the shoulder is greater than the inner dimension of the holes such that upon insertion of the pegs into the holes, the shoulder limits how far the peg can be inserted. By inserting two or more crane block support arms of the plurality of crane block support arms into selected holes of the base, the two or more crane block support arms support a selected crane block.

### CROSS-REFERENCE TO RELATED APPLICATION

This application claims the benefit of U.S. provisional application No. 63/017,804 filed on Apr. 30, 2020, the disclosure of which is incorporated by reference.

### FIELD

This invention relates to the field of construction equipment and more particularly to a device for storage and transportation of a crane block.

### BACKGROUND

Crane blocks (or otherwise known as load blocks) are the part of a crane that hoists objects, usually including a hook, swivel, bearing, sheaves, pins and a frame. The crane block is suspended by cables, ropes or chains. For lifting heavy items, the crane block is often very large and heavy, some as heavy as a ton.

Crane accidents are often reported in the news, the most common being the entire crane toppling, but there are many workers crushed by crane blocks that fall over onto the worker. In many construction sites, there are often several crane blocks are present for lifting different types of objects. Further, being that the crane blocks are so heavy, if the crane block is not in the correct position, it is difficult to string the crane block (e.g. threading the cable through the sheaves of the crane block) if the crane block is not upright. As the crane block is not very stable when laid in a side (e.g. for threading with a cable), the crane block may fall over and hurt or kill a worker, as has happened in the past.

What is needed is a device that will safely hold a crane block for storage, transportation, and stringing.

### SUMMARY

In one embodiment, a crane block holder is disclosed including a base made of steel and that has a thickness of at least ½ inch and also has several holes cut or formed therein. Each hole has an inner dimension. There are several crane block support arms. Each crane block support arm has an arm portion connected to a peg that has a shoulder. An outer dimension of the peg is less than or equal to the inner dimension of the holes allowing snug insertion. An outer dimension of the shoulder is greater than the inner dimension of the holes such that upon insertion of the pegs into the holes, the shoulder limits how far the peg can be inserted. By inserting two or more crane block support arms of the plurality of crane block support arms into selected holes of the base, the two or more arms support a selected crane block.

In another embodiment, a method of holding a crane block is disclosed including inserting pegs that are attached to two or more crane block support arms of a plurality of crane block support arms into selected holes of a base configured to hold the crane block between the two or more crane block support arms, whereas insertion of the pegs is limited by shoulders that are formed where each peg is welded to an arm portion, the shoulders having a larger width than each of the selected holes.

In another embodiment, a method of making a crane block holder is disclosed including providing a base made of steel and cutting a plurality of holes in the base. Each hole has an inner dimension. A frame is welded beneath a perimeter of the base. A plurality of pegs is formed from steel. Each peg has an outer dimension that is less than or equal to the inner dimension of the holes and each peg has a shoulder, each shoulder having a shoulder outer dimension that is greater than the inner dimension of the holes. An arm portion is welded to each shoulder to form crane block support arms.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of a crane block holder.

FIG. 2 illustrates an exploded perspective view of the crane block holder.

FIG. 3 illustrates a perspective view of the crane block holder from a side.

FIG. 4 illustrates a perspective view of the crane block holder from above.

FIG. 5 illustrates a perspective view of the crane block holder from above, holding a crane block.

FIG. 6 illustrates a front view of a holding arm of the crane block holder.

FIG. 7 illustrates a side view of a holding arm of the crane block holder.

FIG. 8 illustrates a side view of an angled holding arm of the crane block holder.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Throughout this description, the crane block holder 8 is described for holding and/or transporting a crane block 2.

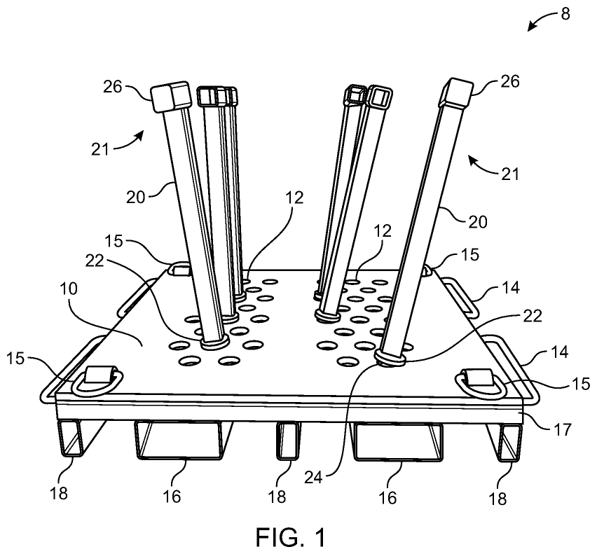

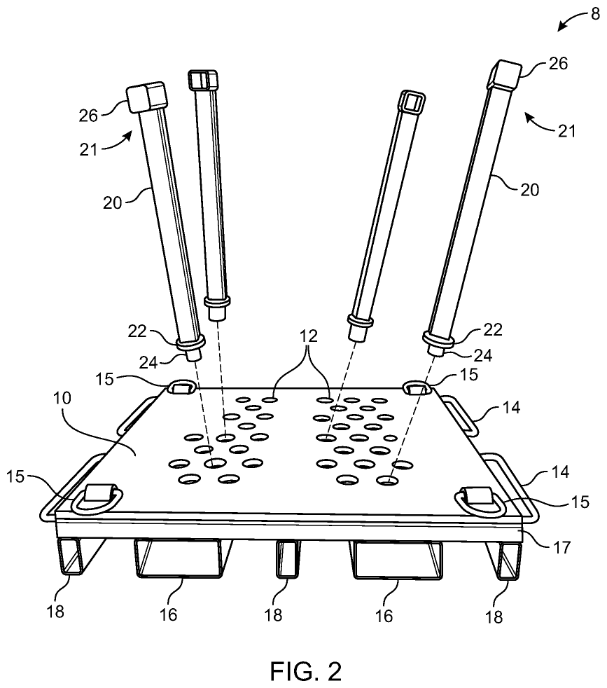

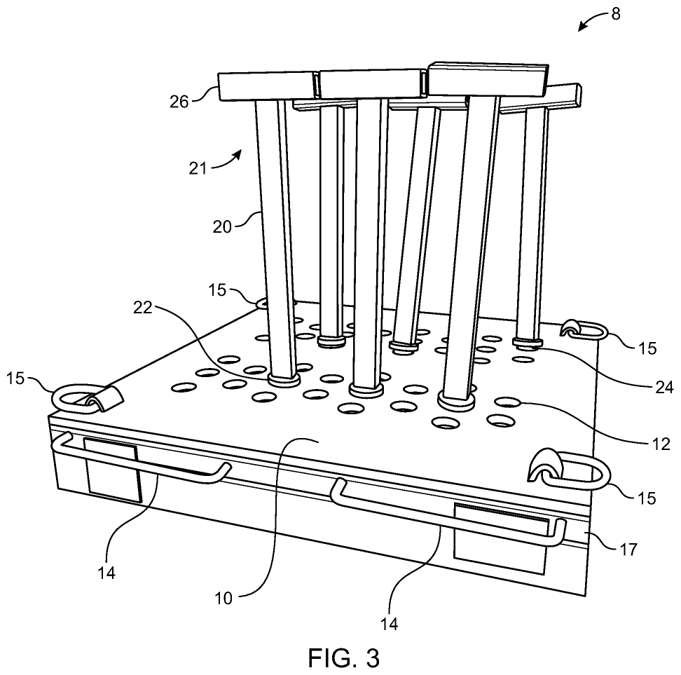

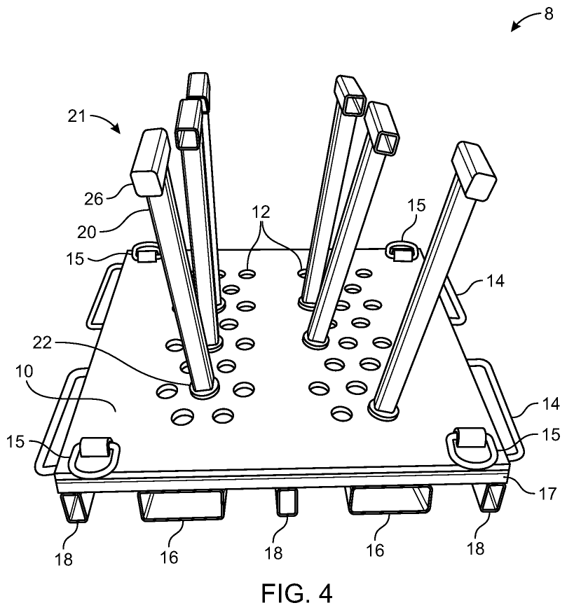

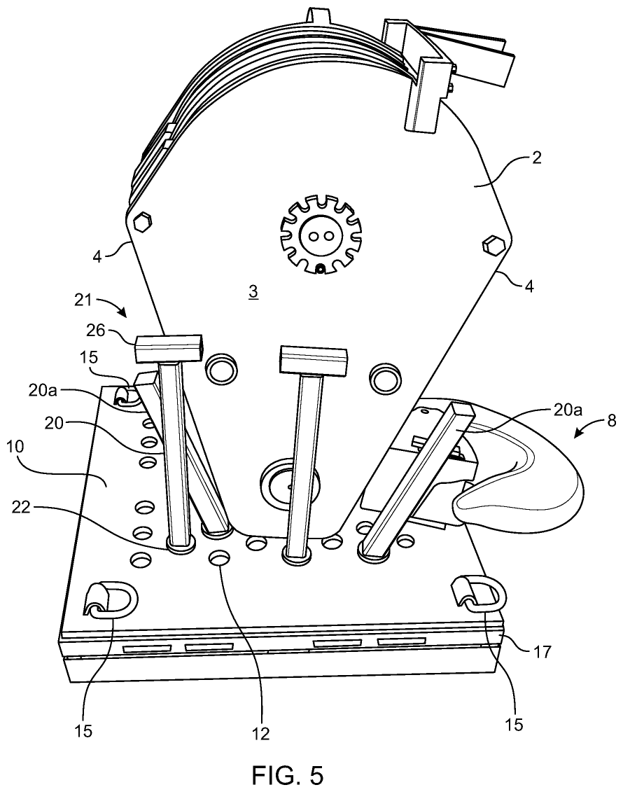

Referring to FIGS. 1, 2, 3, and 4, perspective views of a crane block holder 8 are shown. In some embodiments, the crane block holder 8 has a base 10 that is planar and sturdy for supporting the crane block 2 (see FIG. 5). In a preferred embodiment, the base 10 is made of a solid sheet of steel having a thickness between 0.5 inches and 1.0 inches, preferably ¾ inches thick. In some embodiments, the outer edges of the base 10 form a rectangle or square.

The base 10 is supported by smaller supports 18 as well as larger support 16, the latter being wide enough to receive the tines of a forklift (not shown for brevity reasons), for example, four inches wide. In a preferred embodiment, the smaller supports 18 and larger supports 16 are also made of steel. In this way, the crane block holder 8, with or without the crane block 2, is relocatable by use of a forklift. Also, for transporting, in some embodiments, there are a plurality of D-rings 15. Another way of moving the crane block holder 8 is to attach a cable/chain/rope (not shown for brevity reasons) to one or more of the D-rings 15 to hoist the crane block holder 8 with or without the crane block 2, for example, using the crane (not shown for brevity reasons).

In some embodiments, the crane block holder 8 has ratchet strap loops 14 for securing the crane block 2 with one or more ratchet straps.

In some embodiments, to add additional structural strength to the base 10, there is a frame 17 around bottom edges of the base 10. In such, it is anticipated that the frame 17 be made of steel, for example, 2. inch steel stock.

It is fully anticipated that the frame 17, the smaller supports 18, the larger supports 16, the D-rings 15 and the ratchet strap loops 14 are affixed to the base 10 as known in the industry, for example, by welds.

The base 10 has a plurality of holes 12 (e.g. 30-50 holes) for receiving pegs 22/24 of crane block support arms 21/21a. In some embodiments, the holes 12 are plasma cut into the base 10 and in some embodiments the inner dimension of the holes 12 is 2. inches in diameter. The pegs 22/24 have protrusions 24 that fit snuggly within the holes 12 (e.g. the pegs have an outer dimension, or diameter of 2. inches) and the pegs 22/24 have shoulders 22 that prevent the pegs 22/24 from entering too far within the holes 12 (e.g. a diameter of the shoulders 22 is greater than a diameter of the holes 12, e.g. greater than 2. inches). The pegs are connected/formed with/to arm portions 20/20a that support the crane block 2. As there are many different sizes of crane blocks 2, there are holes 12 into which the pegs 22/24 with arm portions 20/20a are inserted to support crane blocks 2 of various sized. In some embodiments, some arm portions 20 have an endcap 26.

In some embodiments, the pegs 22/24 are rolled steel (e.g. cold rolled 1018 steel) and the arm portion 20/20a is a steel tube of any cross-sectional shape (e.g. circular, rectangular, or square). In the examples shown, the arm portions 20/20a have a square cross-sectional shape and are 2. Inch square stock welded to a surface of the pegs 22/24.

The pegs 22/24 are shown as being round/tubular, permitting insertion into the holes 12 at any degree of rotation. Although it is preferred that the pegs 22/24 are round/tubular, there is no restriction as to the cross-sectional shape of the pegs 22/24 or that the cross-sectional shape of the protrusions 24 be the same as the shoulders 22.

For example, it is fully anticipated that the protrusions 24 be tubular and the shoulders be rectangular. In some embodiments, the protrusions 24 have a square cross-sectional shape allowing four orientations or in some embodiments, the protrusions 24 have a rectangular cross-sectional shape allowing two orientations. In some embodiments, the protrusions 24 are keyed, allowing only a single orientation.

Referring to FIG. 5, a perspective view of the crane block holder 8 from above, holding a crane block 2 is shown. In this view, the substantially planar sides 3 of the crane block 2 are supported by crane block support arms 21 that are perpendicular and the angled sides 4 of the crane block 2 are supported by crane block support arms 21a that are at an angle. Note that, in FIG. 5, the sheaves (grooved discs around which cables are laced or strung) of the crane block 2 are upwardly positioned allowing the sheaves to be laced or strung while the crane block 2 is held by the crane block holder 8. Additionally, once the crane block 2 is held by the crane block holder 8, it is fully anticipated that the crane block holder 8 be transported by crane, forklift, truck, train, etc., while the crane block 2 is held within the crane block support arms 21/21a of the crane block holder 8.

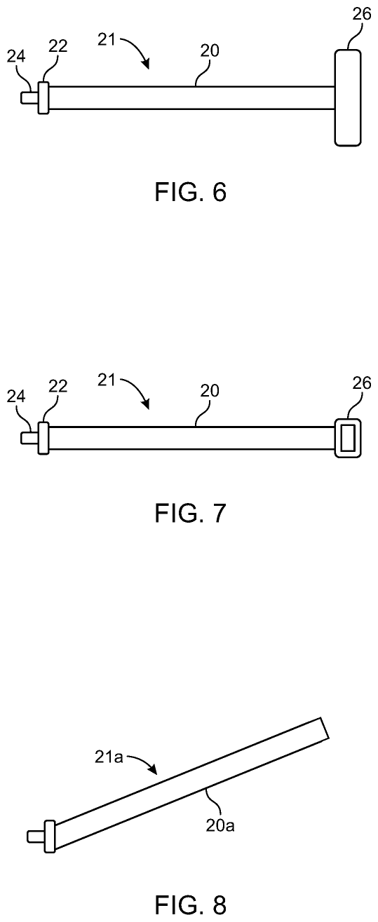

Referring to FIGS. 6, 7, and 8, view of crane block support arms 21/21a of the crane block holder 8 are shown. The pegs 22/24 are designed to fit snugly into the holes 12 of the base 10, limiting insertion into the holes by shoulders 22. As discussed above, in some embodiments, there is an endcap 26 at the end of each arm portion 20/20a. In FIGS. 6 and 7, the arm portion 20 of the crane block support arm 21 is in line (0 degrees) with the peg 22/24 and, therefore, when the crane block support arm 21 is inserted into one of the holes 12, the crane block support arm 21 is perpendicular to the base 10. In FIG. 8, the arm 20a of the crane block support arm 21a is at an angle (anything except 0 degrees) with the peg 22/24 and, therefore, when the crane block support arm 21a is inserted into one of the holes 12, the crane block support arm 21a is at an angle with respect to the base 10.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A crane block holder comprising:
a base made of steel and having a thickness of at least ½ inch;
a plurality of holes cut or formed in the base, each hole having an inner dimension;
a plurality of crane block support arms, each crane block support arm having an arm portion connected to a peg that has a shoulder; an outer dimension of the peg is less than or equal to the inner dimension of the holes and an outer dimension of the shoulder is greater than the inner dimension of the holes such that insertion of the pegs into the holes is limited by the shoulders;
whereas by inserting of two or more of the crane block support arms of the plurality of crane block support arms into selected holes of the base, the two or more crane block support arms will support a selected crane block.

2. The crane block holder of claim 1, wherein base is ¾ inch thick.

3. The crane block holder of claim 1, further comprising a frame supporting the base.

4. The crane block holder of claim 3, wherein the frame is made of two inch steel stock and is welded to the base along a bottom perimeter.

5. The crane block holder of claim 1, further comprising a plurality of smaller supports that distance the base from a surface on which it rests.

6. The crane block holder of claim 5, wherein each of the plurality of smaller supports are two-inch rectangular steel that are welded to the base.

7. The crane block holder of claim 1, further comprising a plurality of larger supports that distance the base from a surface on which it rests, the larger supports having a width of at least 4 inches to accommodate tines of a forklift.

8. The crane block holder of claim 7, wherein each of the plurality of larger supports are two inch by four inch rectangular steel that are welded to the base.

9. The crane block holder of claim 1, wherein the holes are tubular and an inner diameter of the holes is a diameter of 2 inches.

10. The crane block holder of claim 1, wherein the peg is cold rolled, forming the shoulder at one end of the peg and each arm portion is welded to a corresponding one of the shoulders.

11. The crane block holder of claim 3, further comprising a plurality of ratchet strap loop welded to the frame for securing the crane block with ratchet straps.

12. A method of holding a crane block, the method comprising:
inserting pegs that are attached to two or more crane block support arms of a plurality of crane block support arms into selected holes of a base of a crane block holder, the arms being configured to hold the crane block between the two or more of the crane block support arms; and
limiting insertion of the two or more crane block support arms of the plurality of the crane block support arms by shoulders that are formed where each peg is welded to an arm portion, the shoulders having a larger width than each of the selected holes.

13. The method of claim 12, further comprising, after inserting the pegs that are attached to the two or more crane block support arms into the selected holes of the base, placing the crane block between the two or more crane block support arms, thereby holding the crane block on the base, supported by the two or more crane block support arms.

14. The method of claim 13, wherein the step of placing the crane block between the two or more crane block support arms includes positioning the crane block such that sheaves of the crane block are positioned upwardly and away from the base and lacing the sheaves of the crane block with cables or ropes while the crane block is held between the crane block support arms.

15. The method of claim 12, wherein the holes are tubular having an inner diameter and the pegs are cylindrical having an outer diameter that is less than or equal to the inner diameter of the holes.

16. The method of claim 15, wherein the outer diameter is 2 inches and the base is made of ¾-inch steel.

17. A method of making a crane block holder, the method comprising:
providing a base made of steel;
cutting a plurality of holes in the base, each hole having an inner dimension;
welding a frame beneath a perimeter of the base; and
forming a plurality of pegs made of steel, each peg having an outer dimension that is less than or equal to the inner dimension of the holes and each peg having a shoulder, each shoulder having a shoulder outer dimension that is greater than the inner dimension of the holes; and
welding an arm portion to each shoulder to form crane block support arms.

18. The method of making the crane block holder of claim 17, wherein the base is rectangular, the method further comprising welding D-rings onto a top surface of each corner of the base.

19. The method of making the crane block holder of claim 17, wherein the base is rectangular, the method further comprising welding a plurality of ratchet strap loops onto an outer surface of the frame.

20. The method of making the crane block holder of claim 17, further comprising welding a plurality of smaller support and a plurality of larger supports onto a bottom surface of the frame, the larger support having a rectangular opening of 4 inches by 2 inches and spaced apart for accepting tines of a forklift.
